(19) United States
(12) Patent Application Publication
(10) Pub. No.: US 2012/0024061 A1
(43) Pub. Date: Feb. 2, 2012

(54) TRACK MEASUREMENT APPARATUS FOR SPORTS SHOES

(76) Inventor: Cheng-Tang CHIANG, Nantou County (TW)

(21) Appl. No.: 12/846,121

(22) Filed: Jul. 29, 2010

(51) Int. Cl. G01P 15/08

(52) U.S. Cl. 73/510

(57) ABSTRACT

A track measurement apparatus for sports shoes includes a first accelerometer module located at a rear side of a sole of a shoe and a second accelerometer module located at a front side of the sole of the shoe to measure acceleration alterations of the shoe worn by a user in striding forwards during running, and also derive alterations of angular velocity and angle while the shoe is stridden forwards to get motion status of the shoe.

### FIELD OF THE INVENTION

The present invention relates to a dynamic measurement system of footwear and particularly to a track measurement apparatus for sports shoes.

### BACKGROUND OF THE INVENTION

Gait analysis aims to get motion tracks of people during running or walking through a dynamic graphic technique. In sports medicine, gait analysis can be used to get insight of coordination problems among skeletons, joints and muscles, thereby to get early treatments needed.

For instance, U.S. Pat. No. 6,301,964 discloses a motion analysis system installed on a rear heel of a shoe. It comprises a horizontal accelerometer, a vertical accelerometer and a tilt sensor. Through the horizontal accelerometer and vertical accelerometer, alterations of acceleration in two directions can be obtained. And through the tilt sensor, a tilt direction can also be obtained. The measured data is input into a processor for integration to derive speed and displacement, namely the position of the shoe can be gotten; then the result is sent to a database through a transmission element for saving, thus the positions of the shoe at different times are gathered to get motion tracks of the shoe, i.e. gait analysis of the shoe can be accomplished.

Although the aforesaid conventional technique can get the result of gait analysis, the horizontal accelerometer, vertical accelerometer and tilt sensor are all located outside the shoe, they are prone to be hit and damaged, and positioning function could suffer. It also requires complex calculation to integrate acceleration alterations of the horizontal accelerometer and vertical accelerometer, and get the tilt direction of the tilt sensor to obtain the shoe's position. It also does not have a datum point, hence could generate erroneous measurement on non-lifting foot movements, such as downhill movement. It still leaves a lot to be desired and cannot fully meet requirements.

### SUMMARY OF THE INVENTION

The primary object of the present invention is to provide a track measurement apparatus for sports shoes to simply and quickly get motion status of a shoe.

To achieve the foregoing object, the invention provides a track measurement apparatus for sports shoes located on a sole of a shoe. It includes a measuring device comprising a first accelerometer module, a second accelerometer module, a first signal processing unit and an interrelation processing unit. The first accelerometer module is located at a rear side of the sole of the shoe, and the second accelerometer module is located at a front side of the sole of the shoe. The first and second accelerometer modules detect alterations of accelerations when the shoe is stridden forwards. The first accelerometer module and the second accelerometer module are spaced at a distance which is defined as a rotation radius.

The first signal processing unit and interrelation processing unit are located on the shoe. The interrelation processing unit receives feedback from the first signal processing unit. The first signal processing unit and interrelation processing unit are linked to the first accelerometer module and second accelerometer module to receive the acceleration alterations, and based on the rotation radius, alterations of speed, angular velocity and time are derived by integration while the shoe is stridden, and then another alterations of speed and time are derived by integration to obtain the angle, speed and angular velocity of the shoe leaving the ground, thereby get the motion status of the shoe.

In short, the invention provides many advantages, notably: through a simple integration process module, the speed and angular velocity of the shoe leaving the ground can be derived through integration due to the simple process. Moreover, the first accelerometer module, second accelerometer module, first signal processing unit and interrelation processing unit are embedded in the shoe and less likely to be damaged, thus can meet actual requirements.

The foregoing, as well as additional objects, features and advantages of the invention will be more readily apparent from the following detailed description, which proceeds with reference to an embodiment and the accompanying drawings. The embodiment serves merely for illustrative purpose and is not the limitation of the invention.

### BRIEF DESCRIPTION OF THE DRAWINGS

FIG. 1 is a system block diagram of the invention.

FIG. 2 is a schematic view of an embodiment of an accelerometer module of the invention.

FIG. 3A is a schematic view according to the invention in a measurement condition.

FIG. 3B is a fragmentary enlarged view according to FIG. 3A.

FIG. 4 is a system block diagram of the invention adopted on a shoe equipped with a control module.

FIG. 5 is a schematic view of an embodiment of the invention in a use condition.

### DETAILED DESCRIPTION OF THE PREFERRED EMBODIMENT

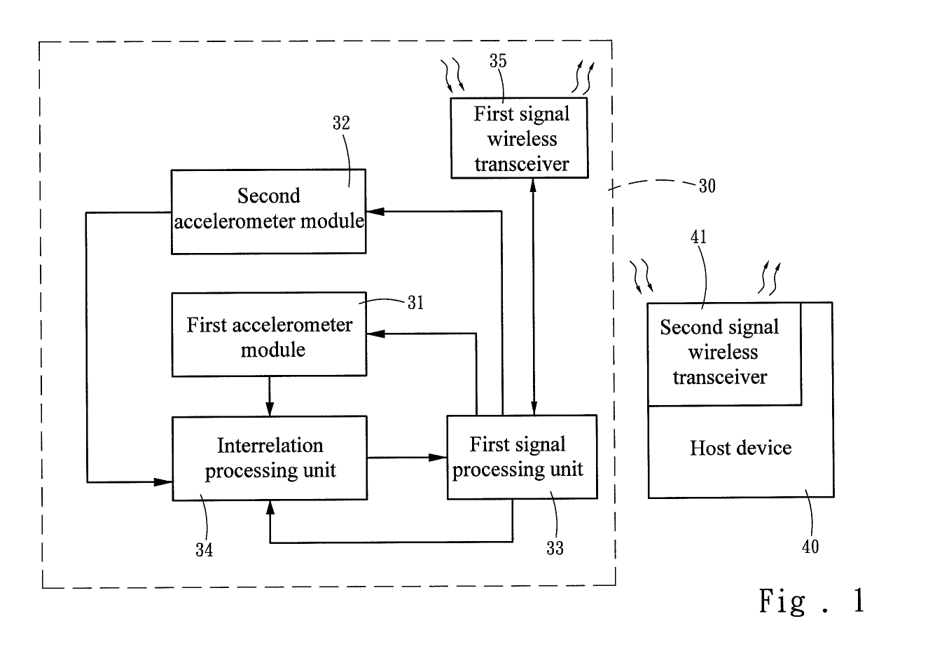

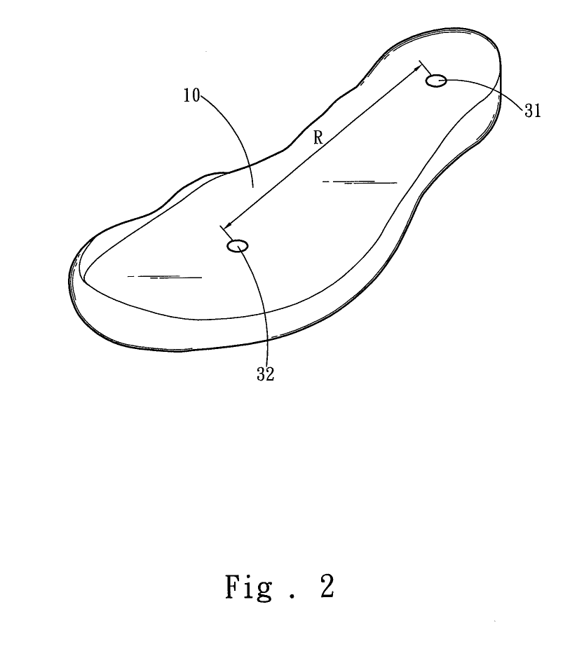

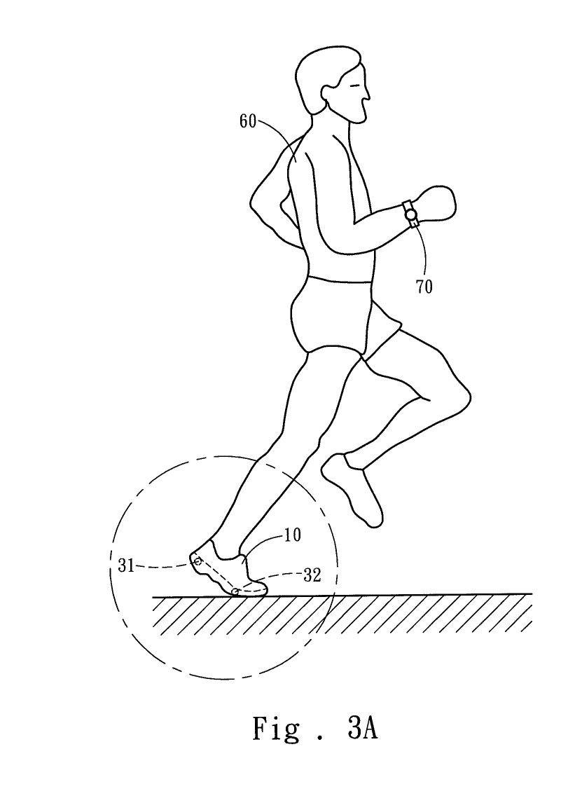

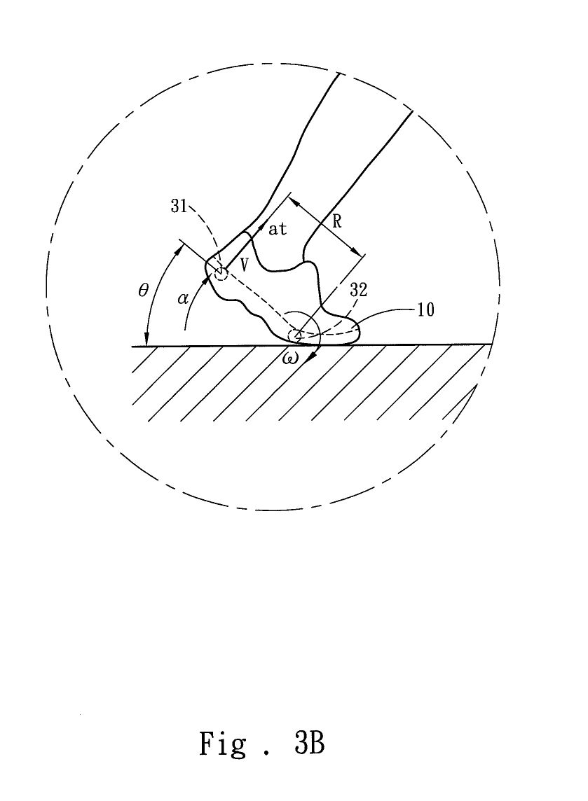

Referring to FIGS. 1, 2, 3A and 3B, the invention includes a measuring device 30 which is linked wirelessly through a first signal wireless transceiver 35 to a host device 40 equipped with a second signal wireless transceiver 41. The measuring device 30 comprises a first accelerometer module 31, a second accelerometer module 32, a first signal processing unit 33 linked to the first signal wireless transceiver 35 and an interrelation processing unit 34. The first accelerometer module 31 is located at a rear side of the sole of a shoe 10, and the second accelerometer module 32 is located at a front side of the sole of the shoe 10. The first accelerometer module 31 and second accelerometer module 32 aim to measure acceleration alterations of the shoe 10 during striding forwards. The first accelerometer module 31 and second accelerometer module 32 are spaced at a distance which is defined as a rotation radius R.

The first signal processing unit 33 and interrelation processing unit 34 also are located on the shoe 10. The interrelation processing unit 34 receives feedback from the first signal processing unit 33. The first signal processing unit 33 and interrelation processing unit 34 are connected to the first accelerometer module 31 and second accelerometer module 32 to receive acceleration alterations aₜ. Based on the rotation radius R and equation aₜ=αR, alterations of an angular acceleration α can be derived; then through another equation V=ωR and an integration process, alterations of speed V, angular velocity w and time can be obtained when the shoe 10 is stridden forwards; through another integration process, alterations of the angle θ and time also can be gotten, and the angle θ, speed V and angular velocity ω of the shoe 10 leaving the ground can be obtained. Thereby the motion status of the shoe can be known.

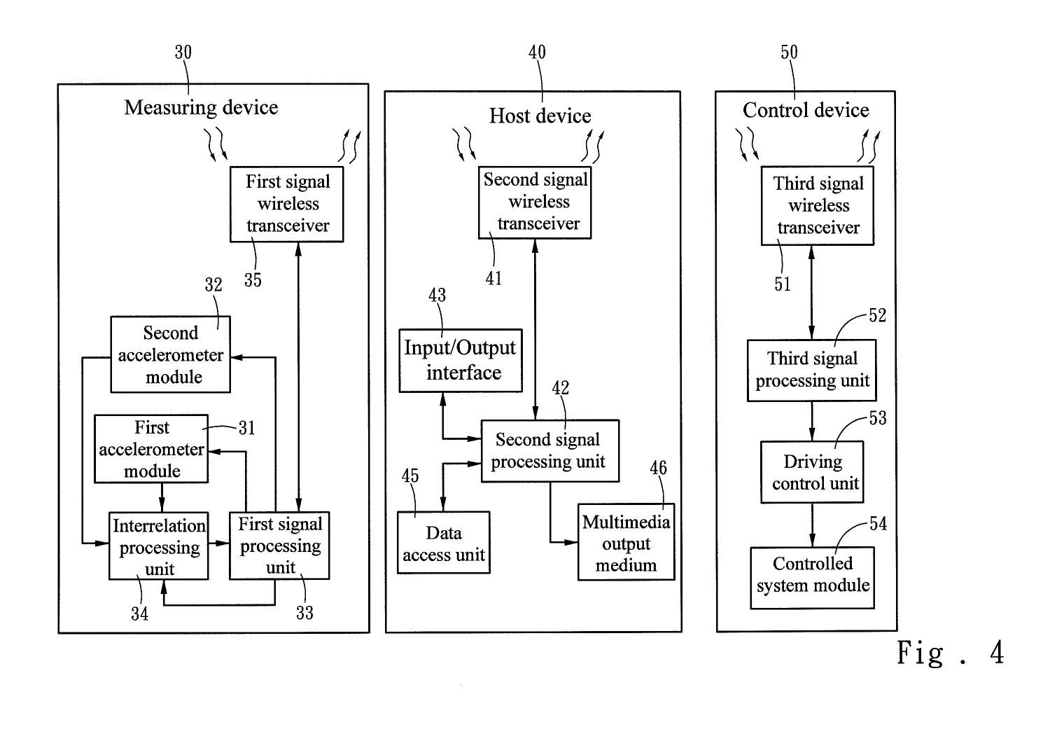

Referring to FIG. 4, the measuring device 30 of the invention can be used to measure an exercise mode of the shoe 10. It can be incorporated with the host device 40 and a control device 50 when in use. The measuring device 30 further includes the first signal wireless transceiver 35. The host device 40 includes the second signal wireless transceiver 41, a second signal processing unit 42, an input/output interface 43, a data access unit 45 and a multimedia output medium 46. The control device 50 includes a third signal wireless transceiver 51, a third signal processing unit 52, a driving control unit 53 and a controlled system module 54.

The measuring device 30, host device 40 and control device 50 are interconnected wirelessly through the first, second and third signal wireless transceivers 35, 41 and 51. The host device 40 is linked to the second signal wireless transceiver 41 through the second signal processing unit 42 to control the measuring device 30 and control device 50, linked to the input/output interface 43 to input/output a control parameter, connected to the data access unit 45 to access data, and linked to the multimedia output medium 46 to output multimedia information.

The control device 50 is linked to the third signal wireless transceiver 51 and driving control unit 53 through the third signal processing unit 52 to receive control signals from the host device 40, and is linked to and controls the controlled system module 54 through the driving control unit 53. In an embodiment, the controlled system module 54 can be a controlled system module (such as a motor module) of a treadmill. After the measuring device 30 obtains the motion status of the shoe, the driving control unit 53 is linked to and controls motion of the controlled system module 54 according to the motion status of the shoe, and the operation of the treadmill can be adjusted in response to actual gaits to meet actual requirements.

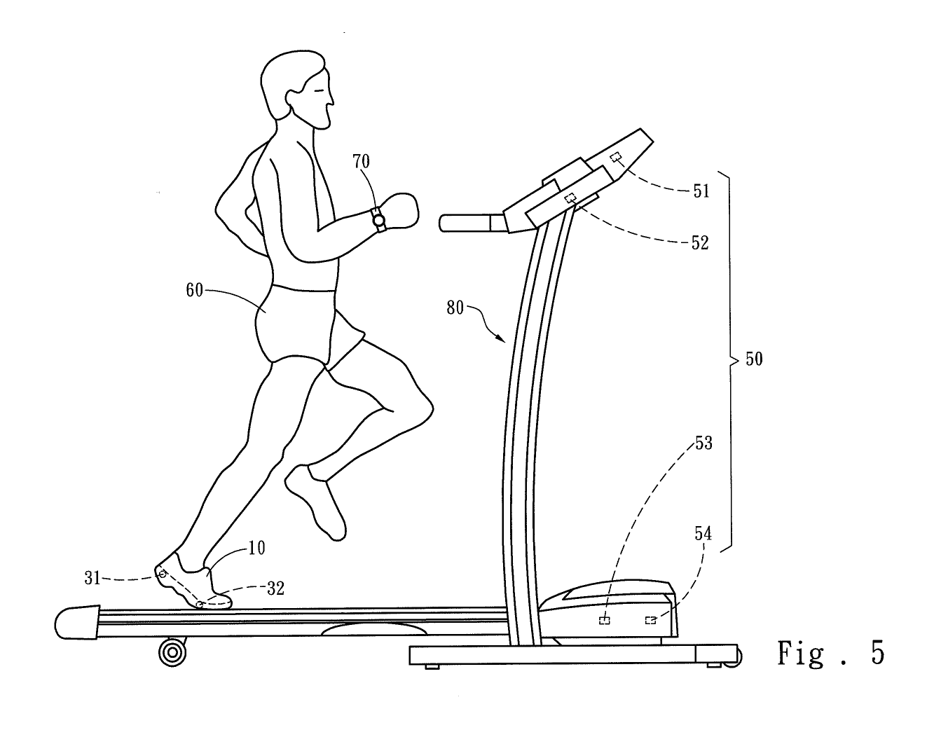

Referring to FIGS. 4 and 5, the host device 40 can be installed on a wristwatch 70, and the control device 50 is installed on a treadmill 80. When a user 60 wears the wristwatch 70 and runs on the treadmill 80, he/she can do a personalized setting through the input/output interface 43. After the measuring device 30 obtains the motion tracks of the shoe 10, through operation and control of the control device 50, the rotational speed of the treadmill 80 is automatically corresponding to the gaits of the user 60 to achieve safety without falling behind the speed of the treadmill 80 and prevent risks. Moreover, after the user 60 has worn the wristwatch 70, he/she can get signals measured by the measuring device 30 through the host device 40 located on the wristwatch 70, namely the user 60 can get the motion tracks through the wristwatch 70 to know the current motion status.

As a conclusion, through the first accelerometer module 31, second accelerometer module 32, first signal processing unit 33 and interrelation processing unit 34, and also the measured accelerations and the distance between the first accelerometer module 31 and second accelerometer module 32, the present invention can derive the speed and angular velocity of the shoe 10 leaving the ground through an integration process. The process is simpler. Moreover, the first accelerometer module 31, second accelerometer module 32, first signal processing unit 33 and interrelation processing unit 34 can be embedded in the shoe 10 without being damaged easily, thus can meet actual requirements.

What is claimed is:

1. A track measurement apparatus for sports shoes, comprising a measuring device located in a shoe, the measuring device including:
a first accelerometer module located at a rear side of a sole of the shoe;
a second accelerometer module located at a front side of the sole of the shoe which is at a bend location of the shoe worn by a user during striding forwards; the first and second accelerometer modules measuring acceleration alterations of the shoe worn by the user during striding forwards, the first and second accelerometer modules being spaced at a distance defined as a rotation radius;
a first signal processing unit linked to the first accelerometer module and the second accelerometer module; and
an interrelation processing unit linked to the first accelerometer module and the second accelerometer module, and receiving feedback from the first signal processing unit to receive the acceleration alterations and to derive alterations of speed, angular velocity and time through a integration process based on the rotation radius while the shoe is stridden forwards, and performing another integration process to derive alterations of angle and time to obtain the angle, speed and angular velocity of the shoe leaving the ground to get motion status of the shoe.

2. The track measurement apparatus of claim 1 further including a host device which comprises a second signal wireless transceiver, a second signal processing unit and an input/output interface; the measuring device including a first signal wireless transceiver, the measuring device being linked wirelessly to the host device through the first signal wireless transceiver and the second signal wireless transceiver, the host device being linked to the input/output interface through the second signal processing unit to input/output a control parameter.

3. The track measurement apparatus of claim 2, wherein the host device further includes a data access unit linked to the second signal processing unit to access data.

4. The track measurement apparatus of claim 2, wherein the host device further includes a multimedia output medium linked to the second signal processing unit to output multimedia information.

5. The track measurement apparatus of claim 2 further including a control device which comprises a third signal wireless transceiver, a third signal processing unit, a driving control unit and a controlled system module; the measuring device, host device and control device being interconnected wirelessly through the first, second and third signal wireless transceivers, the control device being linked to the third signal wireless transceiver and the driving control unit through the third signal processing unit to receive control signals from the host device and connect and control the controlled system module.

6. The track measurement apparatus of claim 5, wherein the host device is installed on a wristwatch and the control device is installed on a treadmill.
